(19) United States
(12) Patent Application Publication
(10) Pub. No.: US 2026/0146635 A1
(43) Pub. Date: May 28, 2026

(54) FASTENING ASSEMBLY

(71) Applicant: Jentech Precision Industrial Co., LTD., TAOYUAN CITY (TW)

(72) Inventors: Fang-Wei YANG, TAOYUAN CITY (TW); Hung-Yi WANG, TAOYUAN CITY (TW); Po-Yuan SU, TAOYUAN CITY (TW); Chang-Chi YEH, TAOYUAN CITY (TW)

(21) Appl. No.: 19/058,320

(22) Filed: Feb. 20, 2025

(30) Foreign Application Priority Data
Nov. 22, 2024 (TW) 113212831

(51) Int. Cl. F16B 5/02

(52) U.S. Cl. CPC F16B 5/0283; F16B 5/0266

(57) ABSTRACT

A fastening assembly includes a first connecting piece, a first locking piece, a second connecting piece, a second locking piece and an elastic piece. The first connecting piece includes a first threaded portion and a first connecting portion. The first locking piece couples with the first threaded portion and abuts against a first plate. The second connecting piece includes a second threaded portion and a second connecting portion. The second locking piece couples with the second threaded portion and abuts against a second plate. The elastic piece connects between the first connecting portion and the second connecting portion. When the first locking piece couples with the first threaded portion and the second locking piece couples with the second threaded portion, the elastic piece is elastically deformed, such that the first plate and the second plate abut against two opposite sides of a third plate.

### RELATED APPLICATIONS

This application claims priority to Taiwanese Application Serial Number 113212831, filed Nov. 22, 2024, which is herein incorporated by reference in its entirety.

### BACKGROUND

### Technical Field

The present disclosure relates to fastening assemblies.

### Description of Related Art

Since the living standards have been rising nowadays, the demand for the quality of electronic products has also accordingly increased. Facing to a huge market of electronic products, various manufacturers are working hard to enhance the market competitiveness of their brands.

To be specific, apart from enhancing the functions and performances of electronic products, how to effectively improve the structural quality of electronic products at low cost, is undoubtedly an important issue that various manufacturers highly concern.

### SUMMARY

A technical aspect of the present disclosure is to provide a fastening assembly, which can effectively enhance the structural strength formed by a plurality of plate bodies.

According to an embodiment of the present disclosure, a fastening assembly includes a first connecting piece, a first locking piece, a second connecting piece, a second locking piece and an elastic piece. The first connecting piece includes a first threaded portion and a first connecting portion. The first connecting portion is opposite to the first threaded portion. The first locking piece is configured to couple with the first threaded portion and abut against a first plate body towards the first connecting portion. The second connecting piece includes a second threaded portion and a second connecting portion. The second connecting portion is opposite to the second threaded portion. The second locking piece is configured to couple with the second threaded portion and abut against a second plate body towards the second connecting portion. The first plate body and the second plate body sandwich a third plate body therebetween. The elastic piece is connected between the first connecting portion and the second connecting portion. When the first locking piece couples with the first threaded portion and abuts against the first plate body towards the first connecting portion, and the second locking piece couples with the second threaded portion and abuts against the second plate body towards the second connecting portion, the elastic piece is elastically deformed, such that the first plate body and the second plate body abut against two opposite sides of the third plate body.

In one or more embodiments of the present disclosure, the first connecting piece further includes a first main body. The first main body is connected between the first threaded portion and the first connecting portion. The first main body is configured to penetrate through the first plate body. The first connecting portion has a first connecting surface. The first connecting surface faces to the first threaded portion. The second connecting piece further includes a second main body. The second main body is connected between the second threaded portion and the second connecting portion. The second connecting portion has a second connecting surface. The second connecting surface faces to the second threaded portion. The elastic piece is connected between the first connecting surface and the second connecting surface.

In one or more embodiments of the present disclosure, the second main body has an annular shape and surrounds the first connecting portion and the elastic piece. The second main body and the first connecting portion are spaced apart from each other.

In one or more embodiments of the present disclosure, the second threaded portion includes a tubular body and a first abutting plate. The tubular body is configured to penetrate through the second plate body. The tubular body has a first threaded hole. The second locking piece is configured to couple with the first threaded hole. The first abutting plate is connected between the tubular body and the second main body. The first abutting plate is configured to abut against the second plate body.

In one or more embodiments of the present disclosure, the tubular body further has a polygonal hole. The first threaded hole and the polygonal hole are located on two opposite sides of the tubular body. The first connecting piece further includes a polygonal column. The polygonal column is connected with a side of the first connecting portion away from the first threaded portion. The polygonal column is configured to be at least partially accommodated in the polygonal hole. A contour of the polygonal column fits with the polygonal hole.

In one or more embodiments of the present disclosure, the second locking piece includes a threaded rod and a second abutting plate. The threaded rod is configured to couple with the first threaded hole. The second abutting plate is connected with the threaded rod. The second abutting plate is configured to abut against the second plate body.

In one or more embodiments of the present disclosure, the threaded rod is spaced apart from the first connecting piece.

In one or more embodiments of the present disclosure, the second connecting portion has a through hole. The first main body penetrates through the through hole.

In one or more embodiments of the present disclosure, the first locking piece has a second threaded hole. The first threaded portion is configured to couple with the second threaded hole.

In one or more embodiments of the present disclosure, the first connecting piece further includes a first main body. The first main body is connected between the first threaded portion and the first connecting portion. The first main body is configured to penetrate through the first plate body. The first connecting portion has a first connecting surface. The first connecting surface faces away from the first threaded portion. The second connecting piece further includes a second main body. The second main body is connected between the second threaded portion and the second connecting portion. The second main body is configured to penetrate through the second plate body. The second connecting portion has a second connecting surface. The second connecting surface faces away from the second threaded portion. The elastic piece is connected between the first connecting surface and the second connecting surface.

In one or more embodiments of the present disclosure, the second connecting portion further has a polygonal hole. The polygonal hole is located on a side of the second connecting portion away from the second threaded portion. The first connecting piece further includes a polygonal column. The polygonal column is connected with a side of the first connecting portion away from the first threaded portion. The polygonal column is configured to be at least partially accommodated in the polygonal hole. A contour of the polygonal column fits with the polygonal hole.

In one or more embodiments of the present disclosure, the first locking piece has a third threaded hole. The first threaded portion is configured to couple with the third threaded hole. The second locking piece has a fourth threaded hole. The second threaded portion is configured to couple with the fourth threaded hole.

According to an embodiment of the present disclosure, a fastening assembly includes a first connecting piece, a first locking piece, a second connecting piece, a second locking piece and an elastic piece. The first connecting piece includes a round rod, a flange and a first threaded portion. The round rod is connected between the first threaded portion and the flange along a direction. The first locking piece is configured to couple with the first threaded portion and abut against a first plate body towards the flange. The second connecting piece includes a second threaded portion and a housing. The housing is connected with the second threaded portion. The housing defines a space therein. The housing is configured to abut against a second plate body. The first plate body and the second plate body sandwich a third plate body therebetween. The flange is located in the space. The second locking piece is configured to couple with the second threaded portion and abut against the second plate body towards the housing. The elastic piece is located in the space and connected between the flange and the housing along the direction. The elastic piece is at a side of the flange away from the second threaded portion. When the first locking piece couples with the first threaded portion and abuts against the first plate body towards the flange, and the second locking piece couples with the second threaded portion and abuts against the second plate body towards the housing, the elastic piece is elastically contracted, such that the first plate body and the second plate body abut against two opposite sides of the third plate body.

In one or more embodiments of the present disclosure, the first connecting piece further includes a polygonal rod. The polygonal rod is connected to a side of the flange away from the round rod along the direction. The second threaded portion has a polygonal hole. The polygonal rod is at least partially located in the polygonal hole.

In one or more embodiments of the present disclosure, the second threaded portion further has a threaded hole. The threaded hole is communicated with the polygonal hole along the direction. The second locking piece includes a threaded rod and an abutting plate. The abutting plate is connected with the threaded rod. The threaded rod couples with the threaded hole. The abutting plate is configured to abut against the second plate body.

In one or more embodiments of the present disclosure, the threaded rod is spaced apart from the polygonal rod.

In one or more embodiments of the present disclosure, the housing has a through hole. The round rod penetrates through the through hole.

In one or more embodiments of the present disclosure, the elastic piece is a spring.

The above-mentioned embodiments of the present disclosure have at least the following advantages: by installing the fastening assembly to the first plate body and the second plate body, the first plate body and the second plate body can abut against two opposite sides of the third plate body, such that the first plate body, the second plate body and the third plate body can be locked together to form a stacked structure, while any relative displacement between these three plate bodies is uneasy to happen, thereby effectively enhancing the structural strength formed by the first plate body, the second plate body and the third plate body.

### BRIEF DESCRIPTION OF THE DRAWINGS

The disclosure can be more fully understood by reading the following detailed description of the embodiments, with reference made to the accompanying drawings as follows:

FIG. 1 is a sectional view of a fastening assembly according to an embodiment of the present disclosure;

FIG. 2 is a sectional view along a sectional line A-A of FIG. 1;

FIG. 3 is a sectional view of a fastening assembly according to another embodiment of the present disclosure; and

FIG. 4 is a sectional view along a sectional line B-B of FIG. 3.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

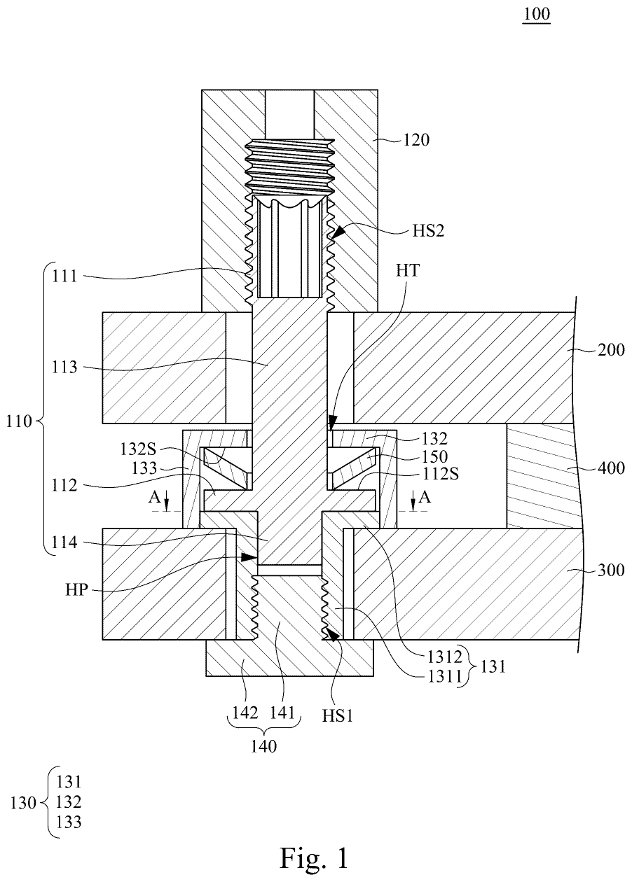

Reference is made to FIG. 1. FIG. 1 is a sectional view of a fastening assembly 100 according to an embodiment of the present disclosure. In this embodiment, as shown in FIG. 1, a fastening assembly 100 includes a first connecting piece 110, a first locking piece 120, a second connecting piece 130, a second locking piece 140 and an elastic piece 150. The first connecting piece 110 includes a first threaded portion 111 and a first connecting portion 112. The first connecting portion 112 is opposite to the first threaded portion 111. The first locking piece 120 is configured to couple with the first threaded portion 111 and abut against a first plate body 200 towards the first connecting portion 112. The second connecting piece 130 includes a second threaded portion 131 and a second connecting portion 132. The second connecting portion 132 is opposite to the second threaded portion 131. The second locking piece 140 is configured to couple with the second threaded portion 131 and abut against a second plate body 300 towards the second connecting portion 132. The first plate body 200 and the second plate body 300 sandwich a third plate body 400 therebetween. The elastic piece 150 is connected between the first connecting portion 112 and the second connecting portion 132. When the first locking piece 120 couples with the first threaded portion 111 and abuts against the first plate body 200 towards the first connecting portion 112, and the second locking piece 140 couples with the second threaded portion 131 and abuts against the second plate body 300 towards the second connecting portion 132, the elastic piece 150 is elastically deformed, such that the first plate body 200 and the second plate body 300 abut against two opposite sides of the third plate body 400.

In this way, by installing the fastening assembly 100 to the first plate body 200 and the second plate body 300, the first plate body 200 and the second plate body 300 can abut against two opposite sides of the third plate body 400, such that the first plate body 200, the second plate body 300 and the third plate body 400 can be locked together to form a stacked structure, while any relative displacement between these three plate bodies is uneasy to happen, thereby effectively enhancing the structural strength formed by the first plate body 200, the second plate body 300 and the third plate body 400. For example, the fastening assembly 100 is suitable to be used in areas such as computers or servers. However, this does not intend to limit the present disclosure.

It is worth to note that, in this embodiment, the second connecting portion 132 of the second connecting piece 130 and the first plate body 200 are spaced apart from each other. Moreover, in the process when the fastening assembly 100 locks the first plate body 200, the second plate body 300 and the third plate body 400 together to form a stacked structure, the second connecting portion 132 and the first plate body 200 remain to be free from contact with each other, facilitating the elastic deformation of the elastic piece 150.

To be specific, in this embodiment, as shown in FIG. 1, the first connecting piece 110 further includes a first main body 113. The first main body 113 is connected between the first threaded portion 111 and the first connecting portion 112. The first main body 113 is configured to penetrate through the first plate body 200. Moreover, the second connecting portion 132 has a through hole HT. The first main body 113 of the first connecting piece 110 also penetrates through the through hole HT of the second connecting portion 132. The first connecting portion 112 of the first connecting piece 110 has a first connecting surface 112S, and the first connecting surface 112S faces to the first threaded portion 111. The second connecting piece 130 further includes a second main body 133. The second main body 133 is connected between the second threaded portion 131 and the second connecting portion 132. The second connecting portion 132 has a second connecting surface 132S, and the second connecting surface 132S faces to the second threaded portion 131. The elastic piece 150 is connected between the first connecting surface 112S and the second connecting surface 132S.

Furthermore, as shown in FIG. 1, the second main body 133 of the second connecting piece 130 has an annular shape and surrounds the first connecting portion 112 and the elastic piece 150. The second main body 133 and the first connecting portion 112 are spaced apart from each other. Thus, when the first connecting portion 112 is moved relative to the second main body 133, the second main body 133 will not resist against the first connecting portion 112, which facilitates the elastic deformation of the elastic piece 150.

In addition, as shown in FIG. 1, the second threaded portion 131 of the second connecting piece 130 includes a tubular body 1311 and a first abutting plate 1312. The tubular body 1311 is configured to penetrate through the second plate body 300, and the tubular body 1311 has a first threaded hole HS1. The second locking piece 140 is configured to couple with the first threaded hole HS1 of the tubular body 1311. The first abutting plate 1312 is connected between the tubular body 1311 and the second main body 133, and the first abutting plate 1312 is configured to abut against the second plate body 300.

Moreover, as shown in FIG. 1, the second locking piece 140 includes a threaded rod 141 and a second abutting plate 142. The threaded rod 141 is configured to couple with the first threaded hole HS1 of the tubular body 1311. The second abutting plate 142 is connected with the threaded rod 141 and configured to abut against the second plate body 300. This means the first abutting plate 1312 and the second abutting plate 142 are configured to abut against two opposite sides of the second plate body 300. On the other hand, the first locking piece 120 has a second threaded hole HS2, and the first threaded portion 111 of the first connecting piece 110 is configured to couple with the second threaded hole HS2 of the first locking piece 120.

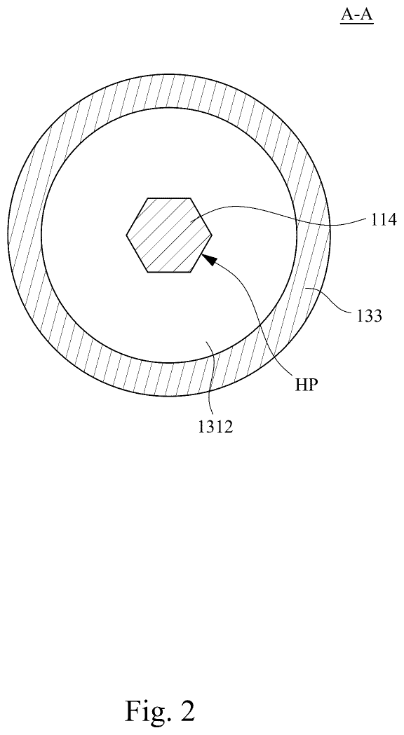

Reference is made to FIGS. 1-2. FIG. 2 is a sectional view along a sectional line A-A of FIG. 1. In this embodiment, as shown in FIGS. 1-2, the tubular body 1311 further has a polygonal hole HP. The first threaded hole HS1 and the polygonal hole HP are located on two opposite sides of the tubular body 1311. Correspondingly, the first connecting piece 110 further includes a polygonal column 114, and the polygonal column 114 is connected with a side of the first connecting portion 112 away from the first threaded portion 111. The polygonal column 114 is configured to be at least partially accommodated in the polygonal hole HP. It is worth to note that, a contour of the polygonal column 114 fits with the polygonal hole HP. Thus, the tubular body 1311 can provide restriction to the polygonal column 114 and the first connecting piece 110 by the polygonal hole HP, avoiding the first connecting piece 110 from free rotation. For example, as shown in FIG. 2, the polygonal column 114 and the polygonal hole HP are both hexagonal. However, this does not intend to limit the present disclosure.

In this embodiment, when installing the fastening assembly 100, a user first penetrates the tubular body 1311 of the second connecting piece 130 through the second plate body 300, and couples the threaded rod 141 of the second locking piece 140 with the first threaded hole HS1 of the tubular body 1311, such that the first abutting plate 1312 of the second connecting piece 130 and the second abutting plate 142 of the second locking piece 140 abut against two opposite sides of the second plate body 300. Afterwards, the user rotates the first locking piece 120 to make the first locking piece 120 couple with the first threaded portion 111 of the first connecting piece 110. Since the polygonal hole HP of the tubular body 1311 provides restriction to the polygonal column 114 and the first connecting piece 110, the condition that the first connecting piece 110 rotates with the first locking piece 120 such that the first locking piece 120 fails to couple with the first threaded portion 111 is avoided. After the first locking piece 120 couples with the first threaded portion 111 of the first connecting piece 110, the first locking piece 120 abuts against the first plate body 200, and the first connecting piece 110 is moved towards the first locking piece 120 as driven by the first locking piece 120, while the first connecting portion 112 of the first connecting piece 110 is also moved towards the first locking piece 120, and the first connecting portion 112 abuts against the elastic piece 150 with the first connecting surface 112S. The compressed elastic piece 150 then abuts the second connecting portion 132 of the second connecting piece 130 towards the first locking piece 120. In this way, the elastic piece 150 is elastically contracted between the first connecting surface 112S of the first connecting portion 112 and the second connecting surface 132S of the second connecting portion 132. Moreover, the elastic piece 150 intends to make the first locking piece 120 and the second locking piece 140 abut against each other, such that the first plate body 200 and the second plate body 300 abut against two opposite sides of the third plate body 400, thereby enhancing the structural strength formed by the first plate body 200, the second plate body 300 and the third plate body 400.

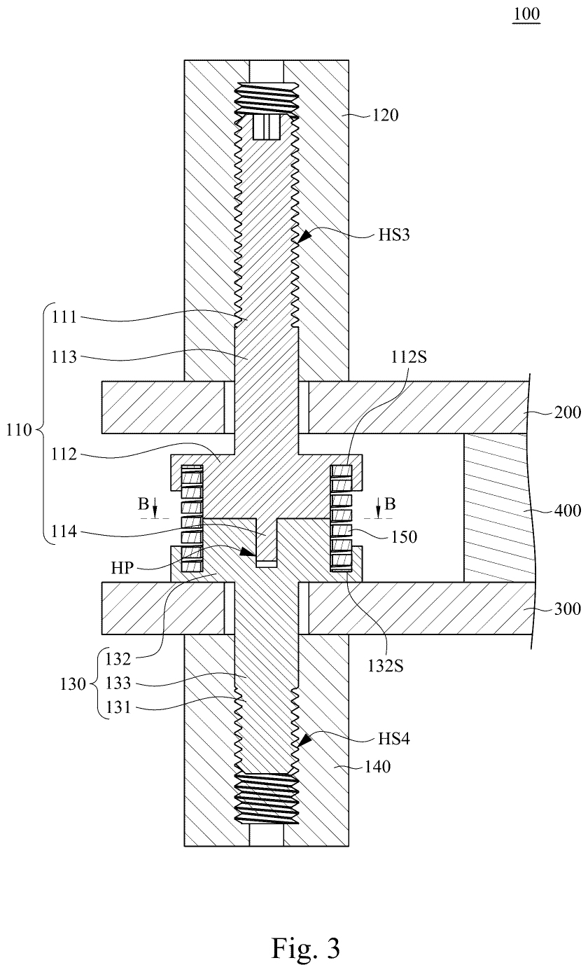

Reference is made to FIG. 3. FIG. 3 is a sectional view of a fastening assembly 100 according to another embodiment of the present disclosure. In this embodiment, as shown in FIG. 3, the first connecting surface 112S of the first connecting portion 112 is away from the first threaded portion 111, and the second connecting surface 132S of the second connecting portion 132 is also away from the second threaded portion 131. Moreover, the second main body 133 of the second connecting piece 130 is configured to penetrate through the second plate body 300.

In addition, as shown in FIG. 3, the first locking piece 120 has a third threaded hole HS3, and the first threaded portion 111 of the first connecting piece 110 is configured to couple with the third threaded hole HS3 of the first locking piece 120. Moreover, the second locking piece 140 has a fourth threaded hole HS4, and the second threaded portion 131 of the second connecting piece 130 is configured to couple with the fourth threaded hole HS4 of the second locking piece 140.

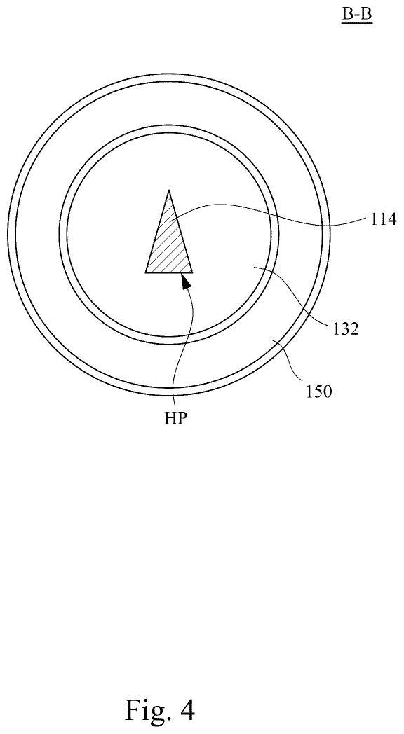

Reference is made to FIGS. 3-4. FIG. 4 is a sectional view along a sectional line B-B of FIG. 3. In this embodiment, as shown in FIGS. 3-4, the second connecting portion 132 further has a polygonal hole HP. The polygonal hole HP is located on a side of the second connecting portion 132 away from the second threaded portion 131. Correspondingly, the first connecting piece 110 further includes a polygonal column 114, and the polygonal column 114 is connected with a side of the first connecting portion 112 away from the first threaded portion 111. The polygonal column 114 is configured to be at least partially accommodated in the polygonal hole HP. It is worth to note that, a contour of the polygonal column 114 fits with the polygonal hole HP. Thus, the second connecting portion 132 can provide restriction to the polygonal column 114 and the first connecting piece 110 by the polygonal hole HP, avoiding the first connecting piece 110 from free rotation. For example, as shown in FIG. 4, the polygonal column 114 and the polygonal hole HP are both triangular. However, this does not intend to limit the present disclosure.

In this embodiment, when installing the fastening assembly 100, a user first penetrates the second main body 133 of the second connecting piece 130 through the second plate body 300, and couples the second locking piece 140 with the second threaded hole HS2, such that the second connecting portion 132 of the second connecting piece 130 and the second locking piece 140 abut against two opposite sides of the second plate body 300. Afterwards, the user rotates the first locking piece 120 to make the first locking piece 120 couple with the first threaded portion 111 of the first connecting piece 110. Since the polygonal hole HP of the second connecting portion 132 provides restriction to the polygonal column 114 and the first connecting piece 110, the condition that the first connecting piece 110 rotates with the first locking piece 120 such that the first locking piece 120 fails to couple with the first threaded portion 111 is avoided. After the first locking piece 120 couples with the first threaded portion 111 of the first connecting piece 110, the first locking piece 120 abuts against the first plate body 200, and the first connecting piece 110 is moved towards the first locking piece 120 as driven by the first locking piece 120, while the first connecting portion 112 of the first connecting piece 110 is also moved towards the first locking piece 120, and the first connecting surface 112S elastically extends the elastic piece 150. In this way, the elastic piece 150 is elastically extended between the first connecting surface 112S of the first connecting portion 112 and the second connecting surface 132S of the second connecting portion 132. Moreover, the elastic piece 150 intends to make the first locking piece 120 and the second locking piece 140 abut against each other, such that the first plate body 200 and the second plate body 300 abut against two opposite sides of the third plate body 400, thereby enhancing the structural strength formed by the first plate body 200, the second plate body 300 and the third plate body 400.

In conclusion, the aforementioned embodiments of the present disclosure have at least the following advantages: by installing the fastening assembly to the first plate body and the second plate body, the first plate body and the second plate body can abut against two opposite sides of the third plate body, such that the first plate body, the second plate body and the third plate body can be locked together to form a stacked structure, while any relative displacement between these three plate bodies is uneasy to happen, thereby effectively enhancing the structural strength formed by the first plate body, the second plate body and the third plate body.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A fastening assembly, comprising:
a first connecting piece comprising a first threaded portion and a first connecting portion opposite to the first threaded portion;
a first locking piece configured to couple with the first threaded portion and abut against a first plate body towards the first connecting portion;
a second connecting piece comprising a second threaded portion and a second connecting portion opposite to the second threaded portion;
a second locking piece configured to couple with the second threaded portion and abut against a second plate body towards the second connecting portion, the first plate body and the second plate body sandwiching a third plate body therebetween; and
an elastic piece connected between the first connecting portion and the second connecting portion,
wherein when the first locking piece couples with the first threaded portion and abuts against the first plate body towards the first connecting portion, and the second locking piece couples with the second threaded portion and abuts against the second plate body towards the second connecting portion, the elastic piece is elastically deformed, such that the first plate body and the second plate body abut against two opposite sides of the third plate body.

2. The fastening assembly of claim 1, wherein the first connecting piece further comprises a first main body, the first main body is connected between the first threaded portion and the first connecting portion, and configured to penetrate through the first plate body, the first connecting portion has a first connecting surface facing to the first threaded portion, the second connecting piece further comprises a second main body, the second main body is connected between the second threaded portion and the second connecting portion, the second connecting portion has a second connecting surface facing to the second threaded portion, the elastic piece is connected between the first connecting surface and the second connecting surface.

3. The fastening assembly of claim 2, wherein the second main body has an annular shape and surrounds the first connecting portion and the elastic piece, the second main body and the first connecting portion are spaced apart from each other.

4. The fastening assembly of claim 3, wherein the second threaded portion comprises:
a tubular body configured to penetrate through the second plate body, the tubular body has a first threaded hole, the second locking piece is configured to couple with the first threaded hole; and
a first abutting plate connected between the tubular body and the second main body, the first abutting plate is configured to abut against the second plate body.

5. The fastening assembly of claim 4, wherein the tubular body further has a polygonal hole, the first threaded hole and the polygonal hole are located on two opposite sides of the tubular body,
the first connecting piece further comprises:
a polygonal column connected with a side of the first connecting portion away from the first threaded portion and configured to be at least partially accommodated in the polygonal hole, a contour of the polygonal column fits with the polygonal hole.

6. The fastening assembly of claim 4, wherein the second locking piece comprises:
a threaded rod configured to couple with the first threaded hole; and
a second abutting plate connected with the threaded rod and configured to abut against the second plate body.

7. The fastening assembly of claim 6, wherein the threaded rod is spaced apart from the first connecting piece.

8. The fastening assembly of claim 2, wherein the second connecting portion has a through hole, the first main body penetrates through the through hole.

9. The fastening assembly of claim 1, wherein the first locking piece has a second threaded hole, the first threaded portion is configured to couple with the second threaded hole.

10. The fastening assembly of claim 1, wherein the first connecting piece further comprises a first main body, the first main body is connected between the first threaded portion and the first connecting portion, and configured to penetrate through the first plate body, the first connecting portion has a first connecting surface facing away from the first threaded portion, the second connecting piece further comprises a second main body, the second main body is connected between the second threaded portion and the second connecting portion, and configured to penetrate through the second plate body, the second connecting portion has a second connecting surface facing away from the second threaded portion, the elastic piece is connected between the first connecting surface and the second connecting surface.

11. The fastening assembly of claim 10, wherein the second connecting portion further has a polygonal hole, the polygonal hole is located on a side of the second connecting portion away from the second threaded portion,
the first connecting piece further comprises:
a polygonal column connected with a side of the first connecting portion away from the first threaded portion and configured to be at least partially accommodated in the polygonal hole, a contour of the polygonal column fits with the polygonal hole.

12. The fastening assembly of claim 10, wherein the first locking piece has a third threaded hole, the first threaded portion is configured to couple with the third threaded hole, the second locking piece has a fourth threaded hole, the second threaded portion is configured to couple with the fourth threaded hole.

13. A fastening assembly, comprising:
a first connecting piece comprising a round rod, a flange and a first threaded portion, the round rod being connected between the first threaded portion and the flange along a direction;
a first locking piece configured to couple with the first threaded portion and abut against a first plate body towards the flange;
a second connecting piece comprising a second threaded portion and a housing connected with the second threaded portion, the housing defining a space therein and being configured to abut against a second plate body, the first plate body and the second plate body sandwiching a third plate body therebetween, the flange being located in the space;
a second locking piece configured to couple with the second threaded portion and abut against the second plate body towards the housing; and
an elastic piece located in the space and connected between the flange and the housing along the direction, the elastic piece being at a side of the flange away from the second threaded portion,
wherein when the first locking piece couples with the first threaded portion and abuts against the first plate body towards the flange, and the second locking piece couples with the second threaded portion and abuts against the second plate body towards the housing, the elastic piece is elastically contracted, such that the first plate body and the second plate body abut against two opposite sides of the third plate body.

14. The fastening assembly of claim 13, wherein the first connecting piece further comprises a polygonal rod connected to a side of the flange away from the round rod along the direction, the second threaded portion has a polygonal hole, the polygonal rod is at least partially located in the polygonal hole.

15. The fastening assembly of claim 14, wherein the second threaded portion further has a threaded hole communicated with the polygonal hole along the direction, the second locking piece comprises a threaded rod and an abutting plate connected with the threaded rod, the threaded rod couples with the threaded hole, the abutting plate is configured to abut against the second plate body.

16. The fastening assembly of claim 15, wherein the threaded rod is spaced apart from the polygonal rod.

17. The fastening assembly of claim 13, wherein the housing has a through hole, the round rod penetrates through the through hole.

18. The fastening assembly of claim 13, wherein the elastic piece is a spring.
